(19) United States
(12) Patent Application Publication
(10) Pub. No.: US 2005/0016604 A1
(43) Pub. Date: Jan. 27, 2005

(54) Fluid control device and method of making it

(75) Inventors: Joseph H. Steinke, Mission Viejo, CA (US); Kim Cockbill, Rancho Santa Margarita, CA (US)

Correspondence Address: STETINA BRUNDA GARRED & BRUCKER, 75 ENTERPRISE, SUITE 250, ALISO VIEJO, CA, 92656, US

(73) Assignee: Control Components, Inc., a Delaware corporation

(21) Appl. No.: 10/624,011

(22) Filed: Jul. 21, 2003

(51) Int. Cl. F16K 3/24

(52) U.S. Cl. 137/625.3

(57) ABSTRACT

Disclosed is a rigid annular valve structure comprised of individual green state discs having partial or complete passages formed therein. The series of green state discs are assembled in an axially aligned stack such that the partial passages of adjacent ones of the green state discs cooperate to collectively define a plurality of substantially radial device passageways for fluid flowing therethrough. The disc passages are formed in the discs prior to the assembly into the stack. The assembled green state discs are heated as a unit in order to simultaneously harden the individual green state discs and to fuse the individual green state discs together to form the rigid annular valve structure. After heating, the rigid annular valve structure may be machined to define interior and exterior peripheries and end faces such that the rigid annular valve structure is suitable for use in a valve assembly.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates to fluid control devices and, more particularly, to a rigid annular valve structure formed by sintering and fusing together a stack of individual green state discs having discs passages. Disc passages formed in the green state discs cooperate to collectively define a multiplicity of radially extending device passageways. The device passageways each define a plurality of substantially right angle turns for reducing the velocity of fluid flowing through the rigid annular valve structure.

The type of fluid control device herein contemplated is disclosed in commonly owned U.S. Pat. No. 5,687,763. The '763 patent discloses a fluid control device including a valve housing with a rigid annular valve structure disposed therein. An axially movable valve plug is slidably mounted in the interior of the valve housing. The rigid annular valve structure in the '763 patent is made up of a stack of annular discs that cooperate to provide a series of substantially radial passageways extending between inner and outer edges of the cooperating discs. Each of the substantially radial passageways has a plurality of substantially right angle turns for reducing the velocity of fluid flowing through the rigid annular valve structure

The individual discs are formed with partial or complete passages therein. Abutting discs having partial passages cooperate together to fully define the substantially radial passageways of the rigid annular valve structure. Likewise, abutting discs having complete passages also cooperate together to fully define the substantially radial passageways of the rigid annular valve structure. The partial passages of the individual discs are partial in the sense that they may not extend entirely through the disc in a radial direction between the inner and outer edges. The partial passages of the individual discs may also not extend entirely through the disc in an axial direction between major faces of the disc. However, the partial passages may extend entirely through the discs in the axial direction and not in the radial direction, or vice versa. The passages may extend entirely through a portion of the discs in either the axial direction or in the radial direction.

In either alternative, in order to define the substantially radial passageways of the rigid annular valve structure, it is necessary to at least partially close off the communication of the passages by utilizing the major faces of the discs. The partial passages may be closed off by abutting together the discs of the stack. The abutting discs may also include either partial or complete passages or a combination thereof. Alternatively, some of the discs in the stack may be separator discs which may not contain any partial or complete passages. Rather, the separator discs may be void of any passages such that the major faces of the separator discs are planar.

Depending on the configuration of the passages in the discs, the substantially radial passageways of the rigid annular valve structure may be substantially straight or may contain a number of turns. Additionally, the substantially radial passageways of the rigid annular valve structure may provide a flow path of constant cross sectional area or a flow path of an expanding cross sectional area. They substantially radial passageways may extend through only one disc. Alternately, the substantially radial passageways may extend through two or more cooperating discs. As disclosed in the '763 patent, the rigid annular valve structure may be configured for fluid flowing in a radially inward direction or in a radially outward direction.

As previously indicated, the partial passages may extend only partially through the disc in one direction. Where the partial passages extend only partially through the disc in the axial direction, then the partial passage in one of the discs fluidly communicates with only one major face of an adjacent disc. Partial passages extending only partially through the disc in the axial direction are formed in a labyrinth configuration. However, partial passages of this type may also be formed in a straight path or in a tortuous path of right angle turns.

Where the partial passages extend only partially through the disc in the radial direction, then the partial passages fluidly communicate with major faces of adjacent ones of the disc. Partial passages that extend in the axial direction are stamped out as holes. Such holes may be rectangularly shaped. The '763 patent teaches that the holes may be formed by wire electrical discharge machining (wire EDM), by water jet machining or other suitable means such that the discs may be fabricated from relatively hard material such as carbide or ceramic material.

Commercially, tungsten carbide has been used to fabricate the individual discs. In practice, this has involved forming an imperforate or blank disc of tungsten carbide powder material. The imperforate disc is initially formed with no disc passages. Before forming into the disc shape, the tungsten carbide powder is mixed with a binding material. A pressing lubricant such as wax or agar, a gelatinous compound, may also be included. The tungsten carbide powder is then compacted into the shape of the disc through the use of a die or by other suitable means such as by injection molding.

The die is configured such that the disc is compacted into the final density and net-shape or near net-shape of the finished disc in order to reduce the amount of final machining that is required. After compaction, the tungsten carbide powder disc is referred to as being in the “green state” and is composed of tightly packed particles of large grain size and weak bonds formed of wax or agar. The wax or agar is added to hold the compacted disc together in its unsintered or green state during subsequent handling.

The compacted green state disc formed is then heated to its sintering temperature such that the grains are interlinked in order to harden the disc into an essentially solid component. During sintering, the majority of the binder is extracted by heat, solvent, catalysis, or by other techniques. After sintering, the passages are formed in the disc by machining. In some commercial practices, the formed imperforate disc is machined to provide the partial or complete passages therein while in the unsintered, unhardened green state. Thereafter, the disc is fired to the sintering temperature in order to harden it.

Regardless of the point at which the passages are formed in the disc, the commercial practice to date has always been to form individual hardened discs and then to align and assemble the hardened discs in a stack to form the rigid annular valve structure. The securement of the stack of hardened discs into a unitary structure has been either by tension rods, as is shown in the '763 patent, or by the use of brazing materials disposed between the adjacent discs. In the case of tungsten carbide discs, a refiring of the assembly at the sintering temperature serves to fuse or unitize the stack of hardened tungsten carbide discs into the rigid annular valve structure.

One of the advantages of utilizing tungsten carbide to form the rigid annular valve structure is the superior erosion resistance of tungsten carbide. In severe service applications where entrained sand may be captured in fluid flowing through the fluid control valve, the rigid annular valve structure must have a very high resistance to erosion from the entrained sand. In this regard, tungsten carbide is the hardest known metal with a compressive strength greater than that of any other metal or alloy. The abrasion resistance of tungsten carbide is up to 1000 times greater than that of steel. Thus, sintered tungsten carbide components are well suited for wear applications in that they have an impressive ability to resist abrasion and erosion.

However, a significant drawback to the use of tungsten carbide is the difficulty in machining components made of tungsten carbide due to its extreme hardness. After sintering, tungsten carbide components can only be machined by diamond-grit grinding devices. A substantial cost in utilizing individual discs made of tungsten carbide is the necessity to grind them flat after sintering. Such discs must be ground flat in order to ensure proper registry and alignment of the discs into the stack formation during the final assembly into the rigid annular valve structure. The grinding process requires considerable time and effort.

Furthermore, the difference in the coefficients of thermal expansion of tungsten carbide utilized in the rigid annular valve structure and other valve assembly components which are typically fabricated from stainless steel may result in valve binding and/or valve leakage at high temperatures. As can be seen, there is an existing need to produce the rigid annular valve structure on a more cost effective basis.

### BRIEF SUMMARY OF THE INVENTION

The present invention specifically addresses and alleviates the above referenced deficiencies associated with the fabrication of metallic articles having high hardness characteristics for fluid control devices. More particularly, the present invention is a rigid annular valve structure and method for forming the same by sintering and fusing together a stack of individual green state discs of stainless steel or tungsten carbide powder mixture.

The method utilized in fabricating the rigid annular valve structure allows for a high degree of process repeatability such that intricately shaped features with tight tolerances may be easily produced. The green state discs are formed with fairly intricate disc passages. The disc passages collectively define a multiplicity of substantially radial device passageways of the rigid annular valve structure. The device passageways each define a plurality of substantially right angle turns for reducing the velocity of fluid flowing through the rigid annular valve structure.

The present invention provides a fluid control device comprising a valve housing constructed and arranged for the flow of fluid therethrough and a rigid annular valve structure providing a multiplicity of substantially radial device passageways mounted within the valve housing. The rigid annular valve structure is mounted such that the fluid flowing within the valve housing can pass through the substantially radial device passageways. The rigid annular valve structure is formed by a series of individual annular green state discs fabricated from metallic or ceramic powder mixture in an unsintered green state such as stainless steel or tungsten carbide powder mixture. Binder material is added to the powder mixture to aid in permanently bonding particles of the powder mixture during sintering of the green state discs.

The individual green state discs have partial or complete disc passages formed therein. The series of green state discs are assembled in a stacked formation so that the partial or complete disc passages of adjacent ones of the green state discs form the substantially radial device passageways. The partial passages are formed in the discs prior to the assembly of the individual green state discs. The individual green state discs are assembled in the stacked formation prior to the hardening of the discs by heat. The assembled stack of green state discs are heated as a unit in order to harden and unitize the individual green state discs together into the rigid annular valve structure.

A method of making the rigid annular valve structure is also disclosed. The method comprises the steps of forming the series of individual annular discs of the unfired stainless steel, tungsten carbide or ceramic powder mixture. Partial or complete disc passages are formed in the individual green state discs. The individual green state discs are aligned in the stack such that the partial or complete disc passages formed therein are closed off to form the substantially radial device passageways of the rigid annular valve structure.

The stack of individual green state discs of unfired stainless steel powder mixture is heated to the fusion temperature of the stainless steel mixture in order to harden the individual green state discs and to unitize the individual green state discs together to form the rigid annular valve structure. During the heating operation, the binder material outgasses such that the stack of green state discs may then sinter in order to unitize and densify the stack. After heating, the rigid annular valve structure is machined as necessary on the inside diameter, outside diameter, and ends such that the rigid annular valve structure is suitable for use in the valve assembly or in an alternative fluid control device.

### BRIEF DESCRIPTION OF THE DRAWINGS

These, as well as other features of the present invention will become more apparent upon reference to the drawings wherein:

FIG. 1 is a sectional view of a valve assembly in which the rigid annular valve structure of the present invention may be employed;

FIG. 2 is a perspective view of a stack of individual green state discs prior to sintering and fusing the stack together to form the rigid annular valve structure;

FIG. 3 is a perspective view of the rigid annular valve structure after sintering and fusing the green state discs together;

FIG. 4 is an exploded perspective view looking downwardly on the stack of green state discs illustrating disc passages formed on an upper opposing face thereof;

FIG. 5 is an exploded perspective view looking upwardly on the stack of green state discs illustrating the substantially flat lower opposing faces formed on respective ones thereof;

FIG. 6 is a plan view of a single one of the green state discs taken along line 6-6 of FIG. 5 illustrating the discs passages extending completely through in a radial direction but only partially through in an axial direction;

FIG. 7 is a side view of the green state disc shown in FIG. 6 illustrating the disc passages extending only partially through in the axial direction;

FIG. 8 is a cross-sectional view of a partial stack of green state discs taken along line 8-8 of FIG. 6 illustrating opposing faces of adjacent ones of the green state discs being disposed in abutting contact to collectively define the plurality of substantially right angle turns oriented in a plane perpendicular to the opposing faces;

FIG. 9 is a plan view of a single one of the green state discs wherein the disc passages thereof define a first and second radially-aligned series of holes extending completely therethrough in the axial direction;

FIG. 10 is a plan view of a pair of the green state discs shown in FIG. 9 in axial alignment such that the first series of holes is superimposed upon and interconnected with the second series of holes; and

FIG. 11 is a cross-sectional view of a partial stack of the green state discs taken along line 11-11 of FIG. 9 wherein opposing faces of adjacent ones of the green state discs are disposed in abutting contact such that the first and second series of holes collectively define the plurality of substantially right angle turns being oriented in a plane perpendicular to the opposing faces.

### DETAILED DESCRIPTION OF THE INVENTION

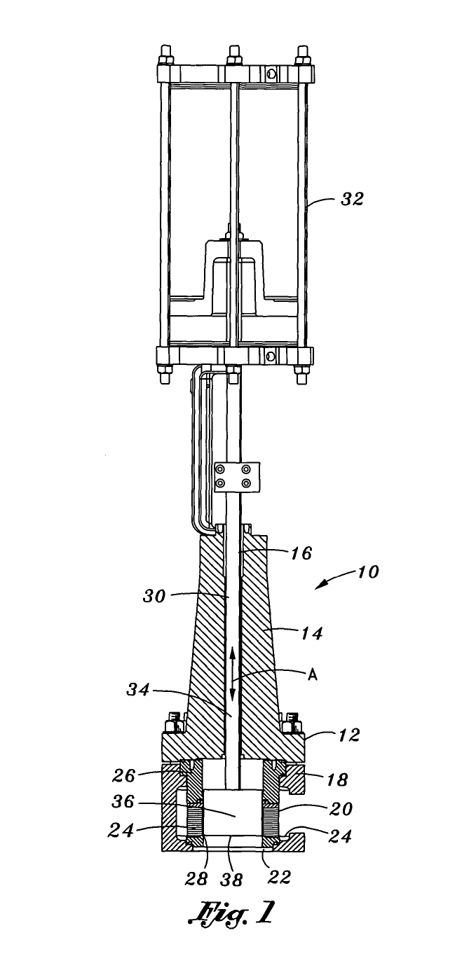

Referring now to the drawings wherein the showings are for purposes of illustrating the present invention and not for purposes of limiting the same, FIG. 1 illustrates a valve assembly 10 in which the rigid annular valve structure 24 of the present invention may be employed. As will be explained in more detail below, the rigid annular valve structure 24 provides a labyrinth of turns for fluid as it flows through device passageways 52 formed therein. The labyrinth of turns provides resistance to flow in order to limit the velocity of the fluid. The rigid annular valve structure 24 of the present invention provides advantages over similar devices of the prior art due in part to the manner in which the rigid annular valve structure 24 is formed.

More specifically, in prior art practices, the disc passages 54 are formed in the individual green state discs 42 by electrical discharge machining, punching, laser cutting or casting. The individual green state discs 42 are then separately sintered and hardened. The hardened green state discs 42 are then assembled and brazed together in a stack 56 formation to form the rigid annular valve structure 24. However, the present invention advantageously forms the discs passages 54 in each one of the individual green state discs 42 after which the rigid annular valve structure 24 is formed by combining the sintering and fusing steps into a single operation.

As can be seen in FIG. 1, the valve assembly 10 has the rigid annular valve structure 24 disposed therein. The valve assembly 10 is comprised of a valve housing 12 having an upper section 14 and a lower section 18. The lower section 18 defines an interior chamber 20 and a flow opening 22. The flow opening 22 is configured to fluidly communicate with the interior chamber 20. The interior chamber 20 receives the fluid therein and the flow opening 22 allows the fluid to escape the interior chamber 20.

As can be seen in FIG. 1, disposed within the interior chamber 20 of the valve housing 12 is an annular sleeve 26 and the rigid annular valve structure 24. The rigid annular valve structure 24 is captured between the sleeve 26 and the lower section 18 of the valve housing 12. The valve assembly 10 may further include a valve plug 34 slidably disposed within the rigid annular valve structure 24. The valve plug 34 is comprised of a plug body 36 and an elongate shaft or rod 30. Both the plug body 36 and the rod 30 may be generally cylindrically configured. It should be noted that the rigid annular valve structure 24 and the sleeve 26 may be configured in alternative shapes with the plug body 36 being configured to be complementary to the rigid annular valve structure 24 such that a sliding fit is provided therebetween.

Attached to the plug body 36 and extending axially from one end thereof is the rod 30 which is advanced through a bore 16 within the upper section 14 of the valve housing 12. The rod 30 is coupled to an actuator 32 which is operative to reciprocally move the valve plug 34 between a closed position and an open position in alternate directions as indicated by the arrow A in FIG. 1. The actuator 32 may be a piston actuator, and may alternatively comprise any type of actuator (e.g., air diaphragm, electric, hydraulic). The plug body 36 includes an end face 38 disposed opposite that from which the rod 30 extends. The valve plug 34 may be moved between the open and closed positions. In the closed position, the end face 38 of the plug body 36 may be placed in sealing engagement with a valve seat 28 of the lower section 18 adjacent the flow opening 22.

As will be recognized, upon movement of the rod 30 to the open position, the same may be selectively returned to its closed position by the movement of the rod 30 in an opposite direction. The engagement of the plug body 36 to the valve seat 28 effectively blocks the flow of fluid through the flow opening 22. In this manner, the plug body 36 may be reciprocated along the direction A within the valve assembly 10 such that the flow rate of fluid passing through the valve assembly 10 may be regulated.

The interior chamber 20 receives fluid that is flowing into the valve housing 12 in a generally radially inward direction from an exterior to an interior thereof. When the valve plug 34 is moved from its closed position towards its open position, fluid is able to flow downwardly across the valve seat 28 and through the flow opening. The fluid passes through the rigid annular valve structure 24 wherein the energy of the fluid is reduced due to the labyrinth flow through the device passageways 52.

Although shown as being incorporated into the valve assembly 10 in FIG. 1, the rigid annular valve structure 24 may be incorporated into any number of alternate fluid control devices. Furthermore, the rigid annular valve structure 24 may be configured to reduce the energy of fluid flowing in either a radially inward direction or in a radially outward direction. The rigid annular valve structure 24 defines device passageways 52 that may have a tortuous flow path.

Alternatively, the device passageways 52 may have non-tortuous flow paths or a combination of tortuous and non-tortuous flow paths. The device passageways 52 are configured for reducing the pressure of the fluid flowing therethrough from the interior chamber 20 prior to exiting the flow opening 22. The fluid flowing into the interior of the rigid annular valve structure 24 undergoes a pressure drop as a result of the flow through the tortuous flow path of the device passageways 52 defined by the rigid annular valve structure 24.

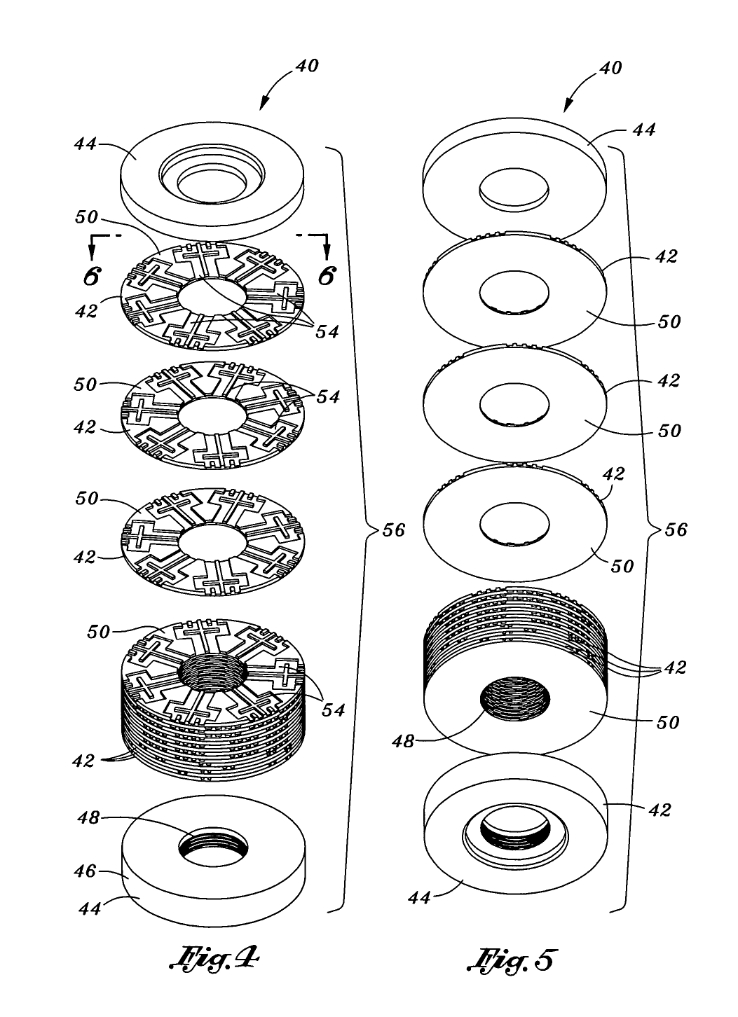

In FIG. 2, shown is an article 40 suitable for sintering into the rigid annular valve structure 24. The article 40 in FIG. 2 is comprised of a stack 56 or series of individual green state discs 42 prior to sintering and fusing the stack 56 together to form the rigid annular valve structure 24. Exploded views of the stack 56 of green state discs 42 may be seen in FIGS. 4 and 5 looking respectively downwardly and upwardly upon the stack 56, showing upper and lower opposing faces 50 of each one of the green state discs 42. FIG. 4 illustrates disc passages 54 formed on upper ones of the opposing faces 50. FIG. 5 illustrates lower ones of the opposing faces 50 which are devoid of disc passages 54.

However, the green state discs 42 may include disc passages 54 on both the upper ones of the opposing faces 50 and the lower ones of the opposing faces 50. In addition, certain ones of the green state discs 42 may include disc passages 54 on both the upper ones of the opposing faces 50 and the lower ones of the opposing faces 50 while remaining ones of the green state discs 42 in the stack 56 may include disc passages 54 on only upper ones of the opposing faces 50.

It is recognized herein that there are many combinations of green state discs 42 having alternate disc passage 54 configurations formed on upper and lower ones of the opposing faces 50 that may be assembled into the stack 56. End discs 44 can also be included at the extreme upper and lower ends of the stack 56 of green state discs 42, as can be seen in FIGS. 4 and 5. The opposing faces 50 of the respective ones of the end discs 44 may be completely devoid of disc passages 54, or they may include disc passages 54 on either or both of the opposing faces 50.

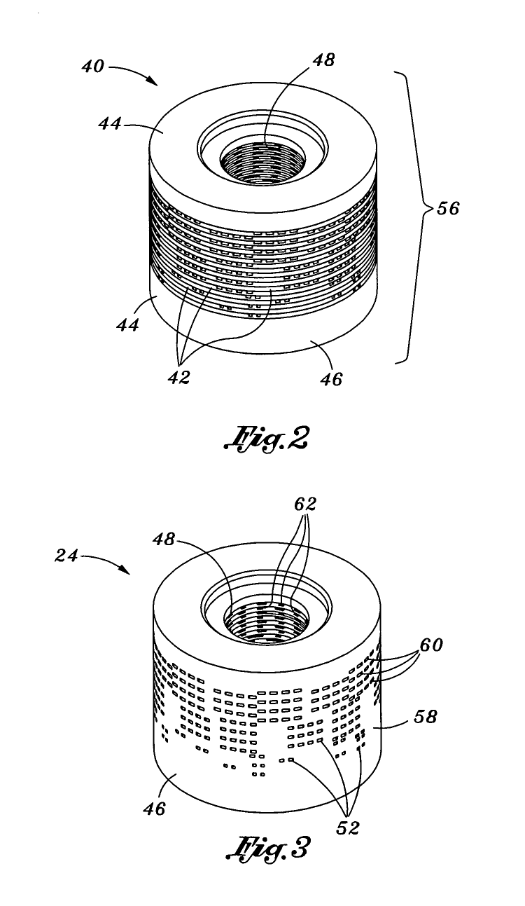

FIG. 3 shows the rigid annular valve structure 24 after the article 40 has been heated to an elevated temperature such that the individual green state discs 42 are sintered and fused together to form a unitized sintered rigid body 58. As was earlier mentioned, the rigid annular valve structure 24 has a multiplicity of annularly and axially spaced, generally radially extending device passageways 52. As shown in FIGS. 2 through 5, the rigid annular valve structure 24 has exterior and interior peripheries 46, 48. The device passageways 52 fluidly communicate between the exterior and interior peripheries 46, 48 of the rigid annular valve structure 24.

As will be described in greater detail below, each one of the discs 42 are formed of a powder mixture such as stainless steel or tungsten carbide powder mixture and are referred to as being in the “green state”. Binder material such as cobalt or nickel may be added to the powder mixture along with a small amount of wax or agar, a gelatinous compound, to hold the discs 42 together in their unsintered or green state. The discs 42 are referred to as being in the green state in the sense that the discs 42 are composed of tightly packed particles of large grain size. The tightly packed particles are held together with weak bonds of wax or agar formed therebetween. The powder mixture is compacted into the shape of the green state disc 42 by injection molding or other suitable means.

Regarding materials from which the green state discs 42 may be fabricated, it is contemplated that stainless steel powder mixture, cobalt alloy powder mixture or tungsten carbide powder mixture may be utilized. The stainless steel, cobalt alloy and tungsten carbide powder mixtures are provided in an unsintered green state to form the green state discs 42. However, it is recognized herein that there are many other metallic powder mixtures as well as certain ceramic powder mixtures that may be provided in an unsintered green state in order to fabricate the green state discs 42. For example, various cements, polymers and cemented carbides may also be suitable for use in fabricating the green state discs 42. Selection of the powder mixture may be based on the mechanical and physical properties of the material in the sintered or hardened state such that the finished article 40 is compatible for use in the rigid annular valve structure 24.

Stainless steel powder mixture in an unsintered green state is a preferred material from which the green state discs 42 may be fabricated due to its favorable hardness characteristics. In addition, sintered stainless steel has a high compressive strength, high hardness at high temperatures, and a high resistance to abrasion and corrosion making it ideal for use in fluid control devices where high-pressure, high-temperature fluid carrying entrained sand can quickly erode away valve components such as the disc passages 54, the plug body 36 and the valve seat 28. Furthermore, the coefficient of thermal expansion of the rigid annular valve structure 24 fabricated from stainless steel is compatible with other components of the valve assembly as such components are also typically fabricated from stainless steel. Thus, the rigid annular valve structure 24 fabricated from stainless steel is ideal for use in valve assemblies that operate under high wear conditions and in corrosive environments similar to those found in petroleum processing plants and in power plants.

Referring to FIGS. 4 and 5, each one of the individual green state discs 42 in the stack 56 includes the opposing faces 50 defining the thickness thereof. Certain ones of the individual green state discs 42 in the stack 56 define disc passages 54 formed between the opposing faces 50. As can be seen in FIG. 2, the series of green state discs 42 are mounted in the stack 56 with the opposing faces 50 being disposed in abutting contact. The green state discs 42 are axially aligned and angularly oriented in a manner such that the disc passages 54 of adjacent ones of the green state discs 42 collectively define the plurality of substantially right angle turns of the generally radially extending device passageways 52.

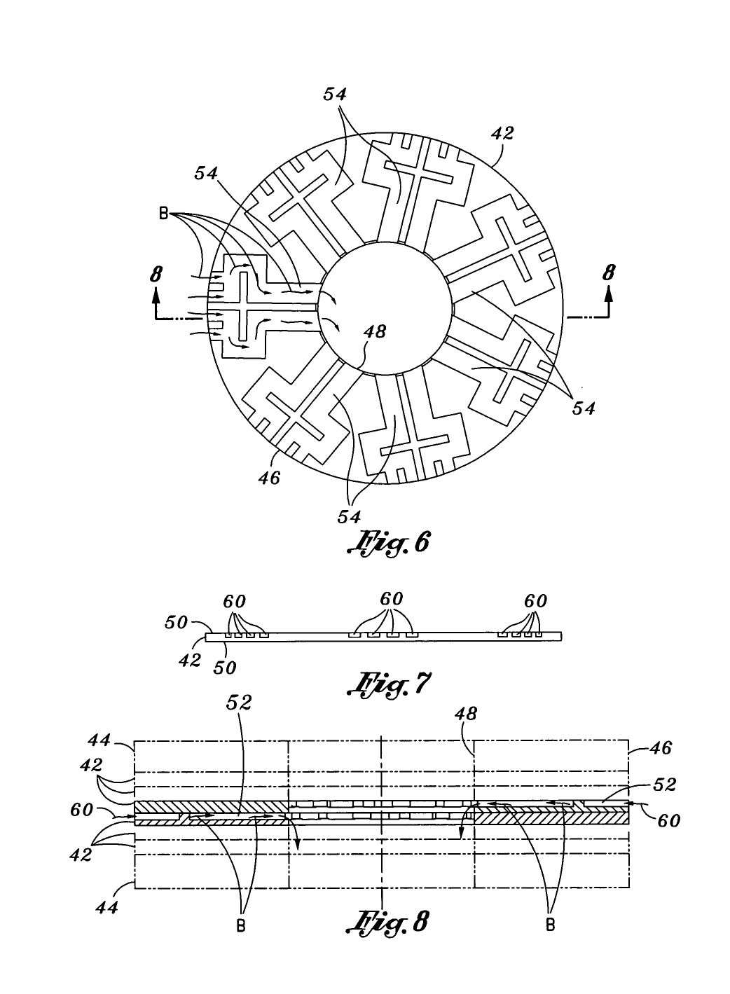

Referring now to FIGS. 6 and 7, the disc passages 54 of respective ones of the green state discs 42 may extend completely therethrough in a radial direction but only partially through in an axial direction. For example, as shown in FIG. 4, each one of the green state discs 42 in the series is substantially identically configured with the disc passages 54 extending completely through in the radial direction but only partially through in the axial direction. However, it is contemplated that various combination of green state discs 42 having alternate configurations of disc passages 54 may be assembled to form the rigid annular valve structure 24 in order to alter the flow characteristics of the valve assembly 10.

As shown in FIG. 4, the series of green state discs 42 having the partially axially extending disc passages 54 are angularly aligned. In this manner, the respective ones of the disc passages 54 of adjacent ones of the green state discs 42 may collectively form the device passageways 52 of the rigid annular valve structure 24. The device passageways 52 define the plurality of substantially right angle turns. In the case of a series of substantially identical green state discs 42 having partially axially extending disc passages 54, the plurality of substantially right angle turns are oriented in a plane that is generally parallel to the opposing faces 50 along the direction of the arrows B as shown in FIGS. 6 and 8.

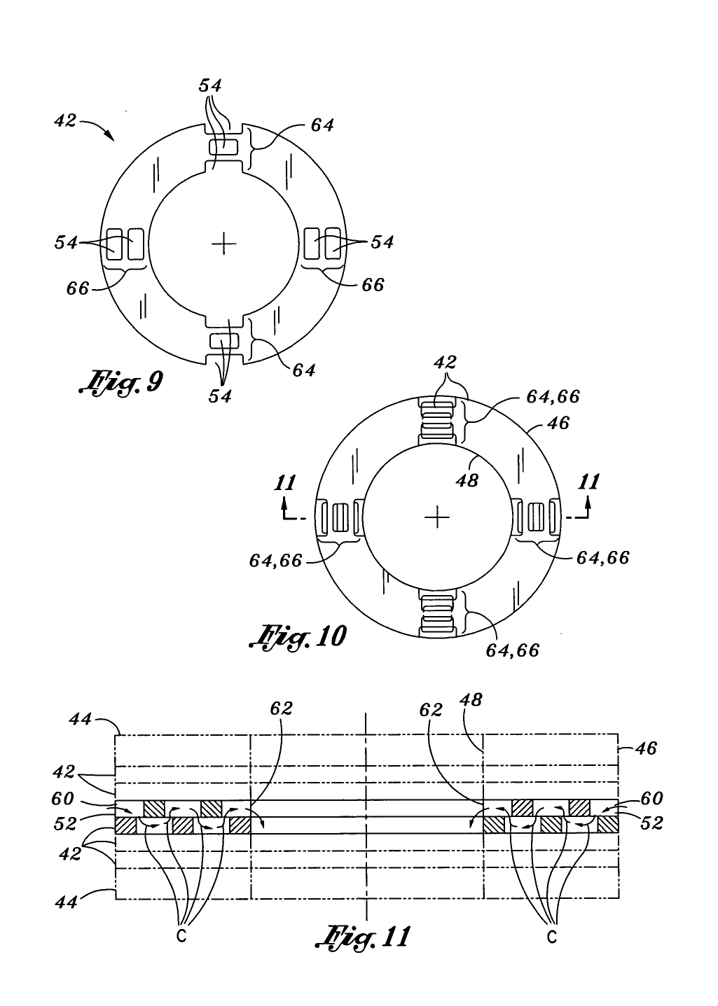

Alternatively, the disc passages 54 of respective ones of the green state discs 42 may extend completely through in the axial direction but only partially through in the radial direction. For example, as shown in FIG. 9, the disc passages 54 define two repeating patterns of a first radially-aligned series of holes 64 and a second radially-aligned series of holes 66. The first and second radially-aligned series of holes 64, 66 extend completely therethrough in the axial direction but only partially through in the radial direction. The first series of holes 64 are angularly offset from the second series of holes 66 in each one of the green state discs 42. As shown in FIG. 9, the first series of holes 64 is angularly offset about 90° from the second series of holes 66 with each of the green state discs 42 being substantially identically configured. Keying features may be included in the green state discs 42 as an aid in aligning the green state discs 42 in the stack 56.

Although the first and second series of holes 64, 66 shown in FIG. 9 are illustrated as being generally rectangularly shaped, it is contemplated that the series of holes 64, 66 may be configured an a wide variety of shapes with alternative degrees of angular offset between the first and second series of holes 64, 66. For example, the first and second series of holes 64, 66 may have an L-shaped configuration. When assembled in the stack 56 as shown in FIG. 10, the green state discs 42 are aligned such that the first series of holes 64 in one of the green state discs 42 is superimposed upon and interconnected with the second series of holes 66 of an adjacent one of the green state discs 42. In this manner, the first series of holes 64 and the second series of holes 66 collectively define the plurality of substantially right angle turns. In such a configuration, the substantially right angle turns are oriented in a plane that is generally perpendicular to the opposing faces 50 along the direction of the arrows C as shown in FIG. 11.

Although not shown, separator discs may be included in the stack 56 of green state discs 42 between cooperating pairs of the green state discs 42. Being generally annular in configuration but lacking disc passages 54 in either the upper or lower ones of the opposing faces 50, the separator discs are configured to isolate the cooperating pairs or other combinations of green state discs 42 in the stack 56. In this manner, the flow of fluid between the cooperating pairs or combinations of green state discs 42 in the stack 56 is restricted or confined to movement between the cooperating pairs. Such separator discs are initially provided in the green state similar to the condition in which the end discs 44 and the green state discs 42 with disc passages 54 are provided. If included, the separator discs and end discs 44 are assembled in the stack 56 with the green state discs 42 having disc passages 54. The stack 56 is then sintered and unitized into the rigid annular valve structure 24, as will be described in detail below.

The rigid annular valve structure 24 is fabricated from the article 40 as described above. The rigid annular valve structure 24 comprises a sintered rigid body 58 formed by sintering the stack 56 of individual green state discs 42 under heat. Each one of the radially extending device passageways 52 of the rigid annular valve structure 24 defines a radially inner end 62 and a radially outer end 60. As can be seen in FIG. 3, the radially inner ends 62 are disposed on the interior periphery 48 of the rigid annular valve structure 24. The radially outer ends 60 are disposed on the exterior periphery 46 of the rigid annular valve structure 24.

The exterior and interior peripheries 46, 48 of the article 40 are configured to fluidly communicate with respective ones of the radially outer and inner ends 60, 62. The valve plug 34 is slidably disposed between the interior periphery 48 and is configured to regulate the number of device passageways 52 through which fluid may pass. In this manner, a labyrinth flow is provided for the fluid as it travels through the device passageways 52 from the outer ends 60 to the inner ends 62, or vice versa. The interior periphery 48 may be cylindrically shaped with the valve plug 34 also being sized and shaped complementary to the interior periphery 48.

The method of fabricating the rigid annular valve structure 24 will now be described. The method includes the steps of providing the series of individual green state discs 42, forming each one of the green state discs 42 with opposing faces 50 and disc passages 54, mounting the series of green state discs 42 in an axially aligned stack 56, applying heat to the series in order to simultaneously sinter and unitize the green state discs 42 into the sintered rigid body 58, then machining the sintered rigid body 58 as a unit in order to form the interior and exterior peripheries 46, 48 as well as ends of the rigid annular valve structure 24.

As was previously mentioned, the rigid annular valve structure 24 includes the series of annularly and axially spaced generally radially extending device passageways 52. The device passageways 52 are collectively formed by strategically aligning and orienting adjacent ones of the green state discs 42 such that the disc passages 54 may cooperate to form the tortuous flow paths of the device passageways 52. The device passageways 52 fluidly communicate between the exterior and interior peripheries 46, 48 of the rigid annular valve structure 24. The exterior and interior peripheries 46, 48 of the rigid annular valve structure 24 may be seen in FIGS. 2 through 5.

During the forming step, each of the discs in the stack 56 are initially formed of the powder mixture such as stainless steel powder mixture in an unsintered green state. Thus, the discs are referred to as being in the green state. Tungsten carbide powder mixtures and cobalt alloy powder mixtures may optionally be utilized to fabricate the green state discs 42. However, other metallic powder mixtures as well as certain ceramic powder mixtures may be provided in an unsintered green state in order to fabricate the green state discs 42.

In addition, various polymers and cemented carbides may also be suitable for use in fabricating the green state discs 42. Selection of the appropriate powder mixture may be based on the desired mechanical and physical properties of the article 40 in the sintered and unitized state. Other design parameters such as porosity, chemical purity, and surface characteristics are dependent on the powder mixture composition.

The powder mixture may be provided in a variety of grain sizes ranging from sub-micron up to coarse size. Various percentages of binder material may be added to the powder mixture to aid in permanently bonding the particles of the powder mixture in the sintering step. The binder material may comprise cobalt or nickel, chromium and tantalum to facilitate bonding of the particles of the powder mixture. Other alloys may be added to the powder mixture to aid in the bonding process.

A compacting lubricant, such as wax or agar, a gelatinous compound, may also be added to the powder mixture. The wax or agar acts to hold the individual green state discs 42 together during the subsequent machining, assembly and sintering steps. Alternative compacting lubricants such as thermoplastics, oils and plasticizers may be instead utilized. By varying the grain size of the powder mixture and the chemical composition of the binder alloy, a combination of material properties of the sintered rigid body 58 may be obtained in order to satisfy a given application.

Regarding other materials from which the green state discs 42 may be fabricated, it is contemplated that superalloys, tool steels and cements powder mixtures may also be utilized. Superalloy powder mixtures such as nickel-based superalloys may be selected as they exhibit favorable strength characteristics, favorable creep resistance, and favorable low cycle fatigue properties at high temperatures found in high-performance applications such as in aircraft turbine engines. Grades of tool steel powder mixtures may be selected to form the individual green state discs 42. The tool steel powder mixture may include a small amount of vanadium to improve wear resistance and resistance to cracking and chipping.

Regardless of its composition, the powder mixture is provided in an unsintered green state to form the green state discs 42. As was earlier mentioned, stainless steel powder mixture in an unsintered green state is a preferred material from which the green state discs 42 may be fabricated due to its favorable hardness characteristics, its high compressive strength, and its high resistance to abrasion and corrosion.

It is recognized herein that there are many other metallic powder mixtures as well as certain ceramic powder mixtures and glass powder mixtures that may be provided in an unsintered green state for fabricating the green state discs 42. Selection of the powder mixture may be based on the mechanical and physical properties of the material in the sintered or hardened state such that the finished article 40 is compatible for use in the rigid annular valve structure 24.

In the forming steps, each one of the green state discs 42 is compacted to form the opposing faces 50 thereof. The opposing faces 50 define the thickness of respective ones of the green state discs 42. In the forming steps, the powder mixture is compacted to form the overall shape of the green state discs 42. Additionally, certain ones of the green state discs 42 are formed with disc passages 54 between the opposing faces 50. Alternatively, in a separate step, the disc passages 54 of the green state discs 42 may be separately formed or molded thereinto by other suitable means.

As was described above, the disc passages 54 may include partial or complete disc passages 54 as is shown in FIGS. 4, 6, 7 and 9. During the compaction, the powder mixture is compressed and densified into a net shape or near-net shape of the final part. In commercial practices, the compacting is performed by isostatic pressing, forging, injection molding and a number of other suitable means. The density of the green state discs 42 after compaction depends on the compaction pressure, the dimensions of the compacted part, and the hardness of the powder mixture.

In the mounting step, the series of green state discs 42 are axially aligned in the stack 56 such that the opposing faces 50 of adjacent ones of the green state discs 42 are disposed in abutting contact. In this manner, the disc passages 54 collectively define the device passageways 52 of the rigid annular valve structure 24. As was earlier described, the green state discs 42 are aligned and angularly oriented in a manner such that the disc passages 54 of adjacent ones of the green state discs 42 collectively define the plurality of substantially right angle turns. As was earlier mentioned, keying features may be formed in the green state discs 42 to aid in aligning the green state discs 42 in the stack 56. If included, the separator discs and end discs 44 are also assembled in the stack 56. The desired combination of green state discs 42 are stacked together in such a manner as to achieve intimate inter-layer contact, promoting high-integrity bonding in the subsequent sintering operation.

In the heating or sintering step, heat is applied to the series of green state discs 42 at an elevated temperature in order to form the sintered rigid body 58. The sintering step may be performed under ambient atmospheric conditions or in a controlled-atmosphere furnace such as a vacuum furnace or in an inert atmosphere. In the sintering step, the stack 56 of green state discs 42, end discs 44 and separator discs, if included, are heated to a temperature just below the melting temperature of the powder mixture but high enough to allow bonding or fusion of the individual particles of the powder mixture.

In the sintering step, the individual green state discs 42 are simultaneously sintered (i.e. hardened) and fused (i.e., bonded) to adjacent ones of the green state discs 42. The fusing together of adjacent ones of the green state discs 42 occurs as the particles of the powder mixture of adjacent ones of the green state discs 42 are diffusion bonded together. During the diffusion bonding process, the adjacent ones of the green state discs 42, the end discs 44 and the separator discs, if included, form intercrystalline bonds therebetween. The sintering step induces optimal strength in the sintered rigid body 58 while increasing the density thereof.

In the finishing step, the sintered rigid body 58 may be machined to form the rigid annular valve structure 24 wherein the exterior periphery 46 and the interior periphery 48 of the rigid annular valve structure 24 is finished into the final shape. In this regard, the interior periphery 48 may be bored or machined into a cylindrical shape that is complementary to the configuration of the valve plug 34, as was previously mentioned. The machining of the sintered rigid body 58 forms the rigid annular valve structure 24 such that the exterior periphery 46 fluidly communicates with the radially outer ends 60 of the device passageways 52 while the interior periphery 48 fluidly communicates with the radially inner ends 62 of the device passageways 52.

Like the interior periphery 48, the exterior periphery 46 may also be machined into a cylindrical shape such that the rigid annular valve structure 24 is compatible with the interior chamber 20 of the valve housing 12. Furthermore, an additional machining step may be included wherein the sintered rigid body 58 is machined to form substantially planar ends thereon such that the sintered rigid body 58 may be concentrically disposed between the sleeve 26 and the valve housing 12.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. An article suitable for sintering by heat into a rigid annular valve structure having exterior and interior peripheries, the rigid annular valve structure providing a multiplicity of annularly and axially spaced generally radially extending device passageways which extend between the exterior and interior peripheries, the article comprising:
a series of individual green state discs fabricated from a powder mixture in an unsintered green state, each one of the individual green state discs having opposing faces and a thickness between the faces, with certain ones of the individual green state discs defining disc passages formed between the opposing faces thereof;
the series of green state discs being mounted in a stack with the opposing faces being disposed in abutting contact in a manner such that the disc passages collectively define a plurality of substantially right angle turns of the generally radially extending device passageways.

2. The article of claim 1 wherein:
the disc passages of respective ones of the green state discs extend completely therethrough in a radial direction but only partially through in an axial direction;
each of the green state discs is substantially identically configured; and
the series of green state discs are angularly aligned such that the respective ones of the disc passages of adjacent ones of the green state discs collectively define the plurality of substantially right angle turns which are oriented in a plane generally parallel to the opposing faces.

3. The article of claim 2 wherein the configuration of the green state discs is variable along the stack.

4. The article of claim 2 wherein:
the disc passages of respective ones of the green state discs define a first and second radially-aligned series of holes extending completely therethrough in the axial direction but only partially through in the radial direction, the first series of holes being angularly offset from the second series of holes in each one of the green state discs; and
the series of green state discs are angularly aligned such that the first series of holes in one of the green state discs is superimposed upon and interconnected with the second series of holes of an adjacent one of the green state discs to collectively define the plurality of substantially right angle turns which are oriented in a plane generally perpendicular to the opposing faces.

5. The article of claim 1 wherein the series of individual green state discs are fabricated from a stainless steel powder mixture in an unsintered green state.

6. The article of claim 1 wherein the series of individual green state discs are fabricated from a tungsten carbide powder mixture in an unsintered green state.

7. The article of claim 1 wherein the series of individual green state discs are fabricated from a cobalt alloy powder mixture in an unsintered green state.

8. The article of claim 1 wherein the series of individual green state discs are fabricated from a ceramic powder mixture in an unsintered green state.

9. The method of claim 1 wherein the series of green state discs are fabricated from a tool steel powder mixture in an unsintered green state.

10. The method of claim 1 wherein the series of green state discs are fabricated from a superalloy powder mixture in an unsintered green state.

11. A rigid annular valve structure fabricated from an article as defined in claim 1 comprising:
a sintered rigid body formed by sintering the stack of individual green state discs under heat, the radially extending device passageways of the article defining radially outer and inner ends thereof, with the exterior and interior peripheries of the article being configured to fluidly communicate with respective ones of the outer and inner ends.

12. A valve assembly including the rigid annular valve structure as defined in claim 11 comprising:
a valve housing having the rigid annular valve structure mounted therein such that fluid flowing through the valve housing passes through the device passageways; and
a valve plug slidably disposed within the interior periphery, the valve plug being configured to regulate the number of device passageways through which fluid may pass.

13. The valve assembly of claim 12 wherein the interior periphery and the valve plug are each cylindrically shaped.

14. A method of forming a rigid annular valve structure having a series of annularly and axially-spaced generally radially-extending device passageways fluidly communicating between exterior and interior peripheries of the rigid annular valve structure, the device passageways having radially inner and outer ends, the method comprising:
providing a series of individual green state discs fabricated from a powder mixture in an unsintered green state;
forming each one of the green state discs with opposing faces and a thickness;
forming certain ones of the green state discs with disc passages between the opposing faces thereof;
mounting the series of green state discs in an axially aligned stack with the opposing faces of adjacent ones of the green state discs being disposed in abutting contact such that the disc passages collectively define the device passageways;
applying heat to the series of green state discs to form a sintered rigid body; and
machining the sintered rigid body to form the exterior periphery fluidly communicating with the outer ends of the device passageways and the interior periphery fluidly communicating with the inner ends of the device passageways.

15. The method of claim 14 wherein the series of green state discs are fabricated from stainless steel powder mixture in an unsintered green state.

16. The method of claim 14 wherein the series of green state discs are fabricated from tungsten carbide powder mixture in an unsintered green state.

17. The method of claim 14 wherein the series of green state discs are fabricated from cobalt alloy powder mixture in an unsintered green state.

18. The method of claim 14 wherein the series of green state discs are fabricated from ceramic powder mixture in an unsintered green state.

19. The method of claim 14 wherein the series of green state discs are fabricated from a tool steel powder mixture in an unsintered green state.

20. The method of claim 14 wherein the series of green state discs are fabricated from a superalloy powder mixture in an unsintered green state.

21. The method of claim 14 wherein the exterior and interior peripheries are machined into a cylindrical shape.

22. The method of claim 14 further comprising the step of machining the sintered rigid body to form substantially planar ends thereon.

23. The method of claim 14 wherein the disc passages and the opposing faces of respective ones of the green state discs are formed by injection molding.

24. The method of claim 14 wherein the disc passages are machined by wire electrical discharge machining.

25. The method of claim 14 wherein the disc passages are machined by water jet machining.
